(19) United States
(12) Patent Application Publication
(10) Pub. No.: US 2020/0293003 A1
(43) Pub. Date: Sep. 17, 2020

(54) METHOD FOR CONTROLLING ALARM-CLOCK OF SMART MIRROR

(71) Applicant: CAL-COMP BIG DATA, INC., NEW TAIPEI CITY (TW)

(72) Inventor: Yung-Hsuan LIN, NEW TAIPEI CITY (TW)

(21) Appl. No.: 16/558,579

(22) Filed: Sep. 3, 2019

(30) Foreign Application Priority Data
Mar. 12, 2019 (CN) 201910185435.0

(51) Int. Cl. G04G 13/02; A47G 1/02; G04C 21/04

(52) U.S. Cl. CPC G04G 13/02; G04C 21/04; A47G 1/02

(57) ABSTRACT

A method for controlling alarm-clock of an smart mirror (1) embedded with an image capturing unit (12) includes following steps: activating an alarm-clock program (132) of the smart mirror (1); determining continually whether a pre-set alarm-time arrives; emitting an alarm-sound when the alarm-time arrives; determining whether the status of the image capturing unit (12) matches with a pre-set alarm-relieving condition when the alarm-time arrives; and, stopping the alarm-sound whenever the status of the image capturing unit (12) matches with the alarm-relieving condition. The smart mirror (1) is arranged with a lens hood (17, 18) for shading the image capturing unit (12), and the status of the image capturing unit (12) varies due to the movement of the lens hood (17, 18).

### BACKGROUND OF THE INVENTION

### 1.Technical Field

The invention relates to a smart mirror, and specifically to a method for controlling alarm-clock applied to the smart mirror.

### 2. Description of Related Art

With the progress of times, more and more technologies can be used for assisting consumers to perform their daily activities.

Recently, there is a kind of smart mirror has been released to the market, which is arranged with a mirror, a display screen, and a camera. The smart mirror may reflect user's face by the mirror, and simultaneously captures user's face image through the camera. After analyzing the face image, an analyzing result and makeup information related to the user (especially to user's face) will be displayed on the display screen. Therefore, the user can perform his/her makeup activities according to the suggestions and guidance given from the smart mirror, which is very convenient.

However, a part of functions of such smart mirror is only available while the smart mirror is connecting to the Internet. Similar to other electronic devices such as personal computer (PC), laptop, or tablet computer, if the smart mirror is under attack by hackers, user's privacy may be leaked through the camera arranged on the smart mirror.

In order to avoid the above risk, a part of the electronic devices is arranged with a lid for shelling the camera arranged thereon. By actively covering the camera, the camera can be prevented from being hacked and activated for capturing user's image for evil intentions.

However, arranging the aforementioned lid on the electronic devices may lead the manufacturing cost to increase, it is such a waste of money if the additionally arranged lid can only be used to cover the camera.

### SUMMARY OF THE INVENTION

The invention is directed to a method for controlling alarm-clock of smart mirror, which may control an alarm-clock program of the smart mirror by way of changing the status of an image capturing unit arranged on the smart mirror.

In one of the exemplary embodiments, the method is applied to a smart mirror embedded with an image capturing unit and includes following steps: activating an alarm-clock program of the smart mirror, and keeps determining whether a preset alarm-time arrives; making an alarm-sound when the alarm-time arrives; determining continually whether a status of the image capturing unit matches with a preset alarm-relieving condition; and, stopping making the alarm-sound when the status of the image capturing unit is determined matching with the alarm-relieving condition. Also, the smart mirror is arranged with a lens hood which can be used to cover the image capturing unit, and the status of the image capturing unit varies due to the movement of the lens hood.

In comparison with related art, the present invention covers the image capturing unit of the smart mirror through the lens hood, which may prevent the smart mirror from being hacked and leaking user's privacy through the image capturing unit. Besides, the present invention may directly control the on/off status of the alarm-clock of the smart mirror through moving the lens hood, so as to achieve complex functions and reduce the manufacturing cost.

### BRIEF DESCRIPTION OF THE DRAWINGS

FIG. 1 is a block diagram of a smart mirror according to an embodiment of the present invention.

FIG. 2 is a schematic diagram of a smart mirror according to an embodiment of the present invention.

FIG. 3A is a partial enlargement diagram of a smart mirror according to a first embodiment of the present invention.

FIG. 3B is a partial enlargement diagram of a smart mirror according to a second embodiment of the present invention.

FIG. 4 is a flowchart for setting alarm-clock according to an embodiment of the present invention.

FIG. 5 is a controlling flowchart of alarm-clock according to a first embodiment of the present invention.

FIG. 6 is a controlling flowchart of alarm-clock according to a second embodiment of the present invention.

FIG. 7 is a controlling flowchart of alarm-clock according to a third embodiment of the present invention.

FIG. 8A is a partial enlargement diagram of smart mirror according to a third embodiment of the present invention.

FIG. 8B is a partial enlargement diagram of smart mirror according to a fourth embodiment of the present invention.

### DETAILED DESCRIPTION OF THE INVENTION

The invention is directed to a method for automatically identifying users of body-fat meter, which can automatically identify user identity right after the measurement of the user is finished.

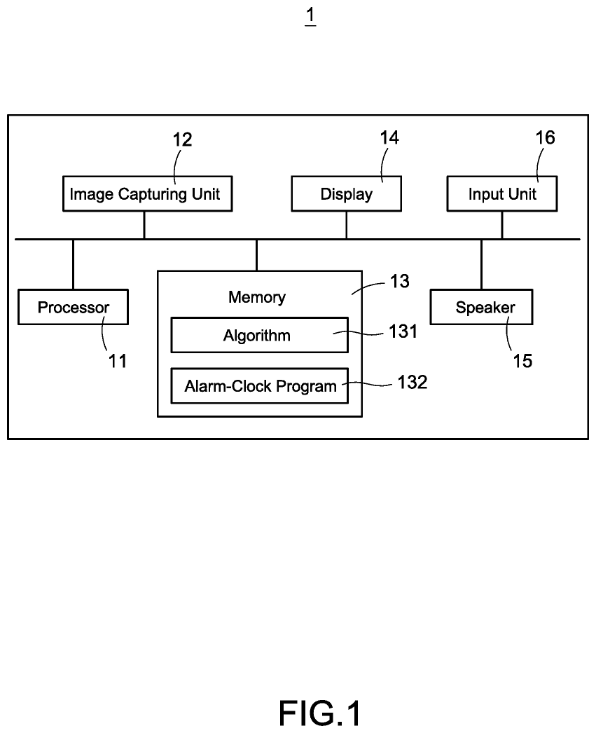

FIG. 1 is a block diagram of a smart mirror according to an embodiment of the present invention. The present invention mainly discloses a method for controlling alarm-clock of smart mirror (referred to as the controlling method hereinafter), the controlling method is applied to a smart mirror 1 as disclosed in FIG. 1, so the smart mirror 1 can assist a user to accomplish not only makeup activities but also an alarm-clock function through the controlling method.

As disclosed in FIG. 1, the smart mirror 1 at least includes a processor 11, an image capturing unit 12, a memory 13, and a display 14, wherein the image capturing unit 12, the memory 13, and the display 14 are electrically connected with the processor 11 respectively through internal buses.

The memory 13 is an electronic component embedded in the smart mirror 1, such as storage, hard-drive (HD), solid-state disk (SSD), etc., for storing data and algorithm 131 of the smart mirror 1. Such algorithm 131 can be, for example, human-face recognition algorithm, face-features analyzing algorithm, etc., not limited thereto. In one of the exemplary embodiments, the smart mirror 1 controls the image capturing unit 12 for capturing external image after being activated, and the processor 11 may perform the algorithm 131 for analyzing the captured external image and determining whether the external image involves a face image of a user. Further, if the external image does involve the face image of the user, the processor 11 analyzes the face image through performing the algorithm 131, so as to obtain different analyzing results (such as skin condition of the user, makeup guidance for each part of user's face, etc.). After above analysis, the smart mirror 1 may display the analyzing results on the display 14, so as to assist the user in his/her makeup activities.

In this embodiment, the memory 13 also stores an alarm-clock program 132. Once the alarm-clock program 132 is executed automatically by the processor 11 or is executed manually by the user, the user is allowed to set a required alarm-time, therefore, the smart mirror 1 is able to make an alarm-sound once the alarm-time arrives, so as to notify the user as his/her wish.

In one of the exemplary embodiments, the smart mirror 1 also includes a speaker 15 electrically connected to the processor 11. When determining that the alarm-time arrives, the smart mirror 1 makes the alarm-sound through the speaker 15 for notification. In another embodiments, the smart mirror 1 may perform an alarm-notification through making a vibration or lightening. In particular, the smart mirror 1 may emit light through an auxiliary light source (arranged next to the speaker, not shown), wherein the auxiliary light source is used for light compensation and adjusting color temperature while user's making-up.

In one of the exemplary embodiments, the aforementioned auxiliary light source is a color temperature adjustable light source. In this embodiment, the user may set that the light emitted by the auxiliary light source for the alarm-notification has the specific color temperature around 2000K to 3000K, so the user can feel comfortable that being immersed in sunlight. Otherwise, the user may set that the light emitted by the auxiliary light source for the alarm-notification has the specific color temperature around 5000K to 6000K, so the user can feel inspired due to the similar feeling under blue sky and white cloud.

In one of the exemplary embodiments, the smart mirror 1 further includes an input unit 16 electrically connected to the processor 11. The user is allowed to operate the smart mirror 1 by controlling the input unit 16, so as to set the aforementioned alarm-time. Besides, the user is also allowed to set each parameter required by the processor 11 for performing such face analyzing procedures.

One of the main technical features of the present invention is that, when the alarm-time arrives and the smart mirror 1 is starting to make the alarm-sound, the processor 11 of the smart mirror 1 determines whether to keep making the alarm-sound or stopping the alarm-sound according to the current status of the image capturing unit 12. By using such technical solution, the manufacturer of the smart mirror 1 can embed the aforementioned alarm-clock function to the smart mirror 1 without modifying the internal circuits and structure of the smart mirror 1.

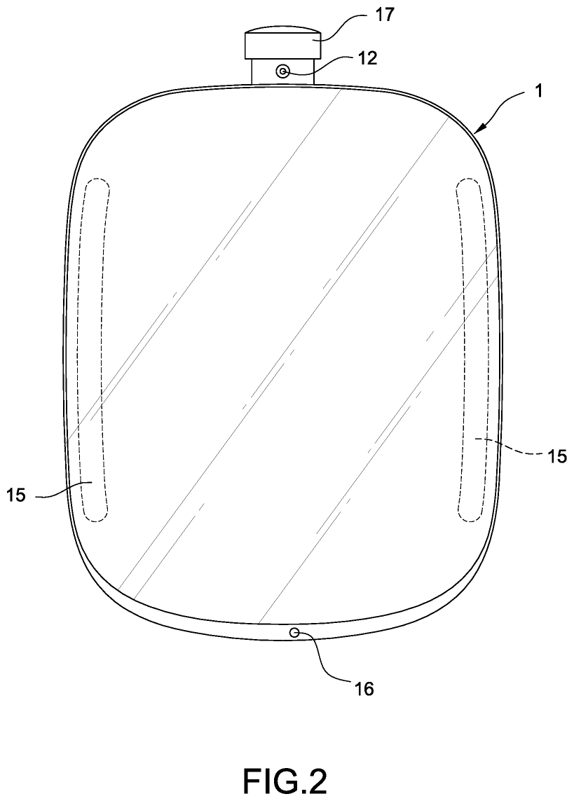

FIG. 2 is a schematic diagram of a smart mirror according to an embodiment of the present invention. As disclosed in FIG. 2, a lens hood 17 is arranged on the shell of the smart mirror 1. The lens hood 17 has not electrical connection with any of the electronic components inside the smart mirror 1 (such as the processor 11, the image capturing unit 12, the memory 13, the display 14, the speaker 15, and the input unit 16). In such structure, even if the smart mirror 1 is hacked, the lens hood 17 is incapable of being controlled by the hackers. In other words, the lens hood 17 in the present invention can only be operated by the user himself/herself, so user's privacy can be effectively prevented from being leaked through the camera (i.e., the image capturing unit 12) arranged on the smart minor 1. However, the aforementioned design is only one of the exemplary embodiments of the present invention, not intended to limit the scope of the present invention.

One of the main technical features of the present invention is that the user is allowed to manually cover the image capturing unit 12 by moving the lens hood 17 (i.e., changing the position of the lens hood 17), so as to change the status of the image capturing unit 12. As described above, the processor 11 may decide whether to stop making the alarm-sound or not after the status of the image capturing unit 12 is changed.

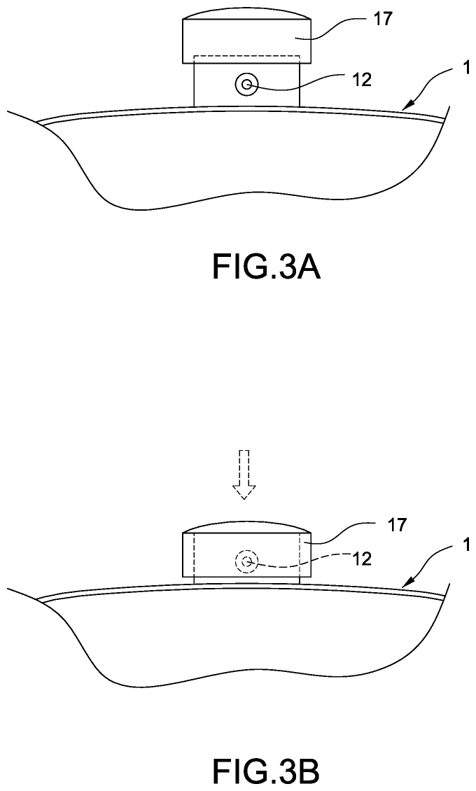

Please refer to FIG. 3A and FIG. 3B, wherein FIG. 3A is a partial enlargement diagram of a smart mirror according to a first embodiment of the present invention, and FIG. 3B is a partial enlargement diagram of a smart mirror according to a second embodiment of the present invention. In this embodiment, the lens hood 17 is basically arranged at a position upon the image capturing unit 12 through a movable structure. When the lens hood 17 is pressed and moves downward, it can cover the image capturing unit 12 and restricts the image capturing unit 12 from capturing external images.

It should be noticed that the arranged position of the lens hood 17 as shown in FIG. 3A and FIG. 3B is only one of the exemplary embodiments of the present invention, the scope of the present invention is not limited thereto.

In particular, the image capturing unit 12 of the smart mirror 1 may have a light sensing part (not shown). Before being covered by the lens hood 17, the image capturing unit 12 may sense external light through the light sensing part. After being covered by the lens hood 17, the image capturing unit 12 cannot sense external light through the light sensing part, or can only sense weak light (for example, the strength of the sensed external light is weaker than a threshold) through the light sensing part.

In one of the exemplary embodiments, the processor 11 determines that the image capturing unit 12 is unexposed to external light when the image capturing unit 12 cannot sense any light through the light sensing part, and determines that the image capturing unit 12 is exposed to external light when the image capturing unit 12 can sense light through the light sensing part. In another one of the exemplary embodiments, the processor 11 determines that the image capturing unit 12 is unexposed to external light when the light strength sensed by the image capturing unit 12 is smaller than a first threshold, and determines that the image capturing unit 12 is exposed to external light when the light strength sensed by the image capturing unit 12 is bigger than the first threshold. In the present invention, the processor 11 is confirming current status of the image capturing unit 12 (i.e., either being exposed to external light or being unexposed to external light) according to the light-affecting level of the image capturing unit 12.

As described above, the arranged position of the lens hood 17 shown in FIG. 3A and FIG. 3B is only an embodiment of the present invention. In another one of the exemplary embodiments, the image capturing unit 12 itself can be set on the smart mirror 1 along with a movable structure (now shown) that can be pressed by the user and hidden in a containing space inside the shell of the smart mirror 1, in other words, the shell of the smart mirror 1 can be used directly as a lens hood for covering the image capturing unit 12. When the user presses the hidden image capturing unit 12, the image capturing unit 12 can be popped up from the containing space inside the smart mirror 1 through the movable structure and again senses external light without being covered by the shell of the smart mirror 1. In such embodiment, the aforementioned lens hood 17 doesn't have to exist.

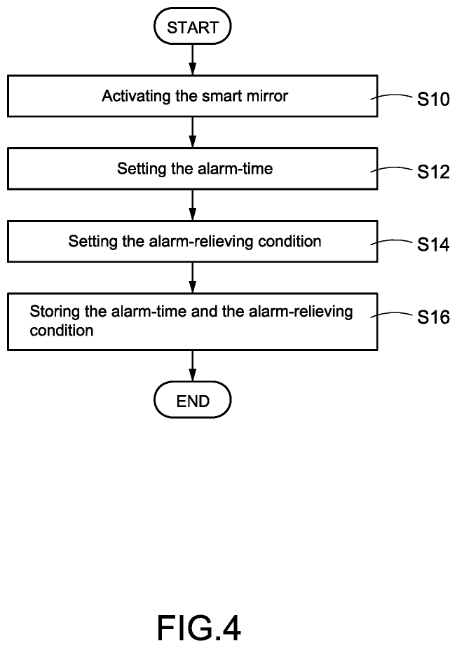

FIG. 4 is a flowchart for setting alarm-clock according to an embodiment of the present invention. For accomplishing the controlling method of the present invention, the user has to first activate the smart mirror 1 (step S10), and then sets the alarm-time required by the user on the smart mirror 1 (step S12), and in particular, sets an alarm-relieving condition asked by the smart mirror 1 (step S14). After all, the smart mirror 1 stores the alarm-time as well as the alarm-relieving condition (step S16). In another embodiment, such alarm-time and alarm-relieving condition can be stored respectively and immediately in step S12 and step S14 after they are set.

By setting the alarm-time and the alarm-relieving condition, the processor 11 of the smart mirror 1 will continually monitor a system time of the smart mirror 1, and controls the smart mirror 1 to make the alarm-sound or the alarm-notification whenever the system time reaches the alarm-time preset by the user in the step S12. In this embodiment, the system time of the smart mirror 1 equals to the current time. Besides, the processor 11 may continually monitor the status of the image capturing unit 12, and controls the smart mirror 1 to stop making the alarm-sound or the alarm-notification once the status of the image capturing unit 12 matches with the alarm-relieving condition preset by the user in the step S14.

It should be mentioned that in the above step S14, the user may set the alarm-relieving condition as the image capturing unit 12 being exposed to external light or the image capturing unit 12 being unexposed to external light. In particular, if the alarm-relieving condition has been set as the image capturing unit 12 being exposed to external light, the processor 11 will control the smart mirror 1 to stop making the alarm-sound after the status of the image capturing unit 12 is determined changing from being unexposed to external light to being exposed to external light. On the other hand, if the alarm-relieving condition has been set as the image capturing unit 12 being unexposed to external light, the processor 11 will control the smart mirror 1 to stop making the alarm-sound after the status of the image capturing unit 12 is determined changing from being exposed to external light to being unexposed to external light.

As described above, the user is allowed to change the status of the image capturing unit 12 (i.e., being exposed/unexposed to external light) through adjusting the position of the lens hood 17, therefore, the smart mirror 1 is controlled by the user to stop making the alarm-sound or the alarm-notification.

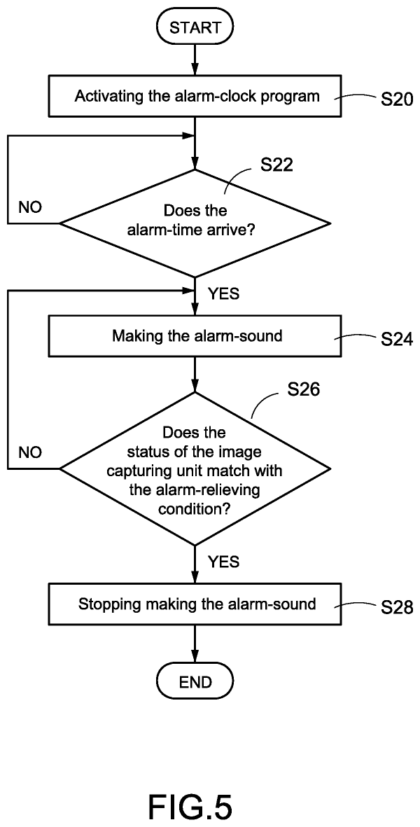

FIG. 5 is a controlling flowchart of alarm-clock according to a first embodiment of the present invention.

After the user sets the alarm-time and the alarm-relieving condition according to the steps disclosed in FIG. 4, the smart mirror 1 is capable of accomplishing the controlling method of the present invention through each step as disclosed in FIG. 5. FIG. 5 discloses steps of one of the exemplary embodiments of the controlling method of the present invention, and the controlling method is basically applied to the smart mirror 1 as disclosed in FIG. 1 and FIG. 2. First, the smart mirror 1 activates the aforementioned alarm-clock program 132 through the processor 11 (step S20). In one of the exemplary embodiments, the processor 11 may automatically activate the alarm-clock program 132 while the system time reaches an activating time (i.e., a time preset for activating the alarm-clock function). In another one of the exemplary embodiments, the processor 11 may passively activate the alarm-clock program 132 after receiving an external operation from the user. In further another one of the exemplary embodiments, the processor 11 may automatically activate the alarm-clock program 132 after the image capturing unit 12 is determined entering a certain status (for example, being exposed to external light or being unexposed to external light). However, the above descriptions are only few embodiments of the present invention, not limited thereto.

After the alarm-clock program 132 is activated, the processor 11 obtains the alarm-time preset by the user, and keeps determining whether the alarm-time arrives (step S22). Also, the processor 11 keeps performing the step S22 for determination before the alarm-time arrives, and the processor 11 controls the smart mirror 1 to make and emit the alarm-sound or the alarm-notification whenever the alarm-time arrives (step S24). In particular, the processor 11 monitors the system time of the smart mirror 1 continually after the step S20, and keeps determining whether the system time of the smart mirror 1 reaches the alarm-time or not in the step S22.

In one of the exemplary embodiments, the processor 11 may control the smart mirror 1 to make and emit the alarm-sound through the speaker 15. In another one of the exemplary embodiments, the processor 11 may control the smart mirror 1 to send an alarm-signal to user's mobile device or IoT devices around the smart mirror 1 (not shown) through the Internet, so as to make and emit the alarm-sound through the mobile device or the IoT devices, not limited thereto.

As shown in FIG. 5, in addition to make the alarm-sound, the processor 11 obtains the alarm-relieving condition present by the user simultaneously after the alarm-timed arrives, and the processor 11 determines if the current status of the image capturing unit 12 matches with the alarm-relieving condition or not (step S26). If the status of the image capturing unit 12 does not match with the alarm-relieving condition yet, the processor 11 goes back to the step S24 for controlling the smart mirror 1 to keep making the alarm-sound. If the status of the image capturing unit 12 does match with the alarm-relieving condition, the processor 11 controls the smart mirror 1 to stop making the alarm-sound (step S28).

In one of the exemplary embodiments, the processor 11 in the step S26 is to first obtain a light-exposed status of the image capturing unit 12, and then determines whether the light-exposed status of the image capturing unit 12 matches with the alarm-relieving condition preset by the user. In this embodiment, the image capturing unit 12 is considered by the processor 11 as being unexposed to external light when the image capturing unit 12 is covered by the lens hood 17 (i.e., the light-strength sensed by the image capturing unit 12 is smaller than a first threshold), and is considered being exposed to external light when the image capturing unit 12 is free from being covered by the lens hood 17 (i.e., the light-strength sensed by the image capturing unit 12 is bigger than the first threshold).

As described above, the user may manually operate the lens hood 17 to change the status (basically the light-exposed status) of the image capturing unit 12, and to control the smart mirror 1 to stop making the alarm-sound through changing the status of the image capturing unit 12. In other words, though the lens hood 17 has no electrical connection with either the processor 11, the image capturing unit 12, the speaker 15, or other electronic components of the smart mirror 1, user can still operate the lens hood 17 to control the smart mirror 1 in activating the alarm-clock program 132 and/or stopping the alarm-sound, which is extremely convenient.

In one of the exemplary embodiments, after the alarm-relieving condition has been set by the user, the processor 11 may automatically set a condition against to the alarm-relieving condition as an activating condition for activating the alarm-program 132. For an instance, if the alarm-relieving condition has been set by the user as the image capturing unit 12 being exposed to external light, the processor 11 may automatically generate an activating condition correspondingly and activates the alarm-clock program 132 in the step S20 whenever the image capturing unit 12 is determined being unexposed to external light (i.e., when the image capturing unit 12 is covered by the lens hood 17). For another instance, if the alarm-relieving condition has been set by the user as the image capturing unit 12 being unexposed to external light, the processor 11 may automatically generate another activating condition correspondingly and activates the alarm-clock program 132 in the step S20 whenever the image capturing unit 12 is determined being exposed to external light (i.e., when the lens hood 17 is opened and the image capturing unit 12 is free from being covered by the lens hood 17).

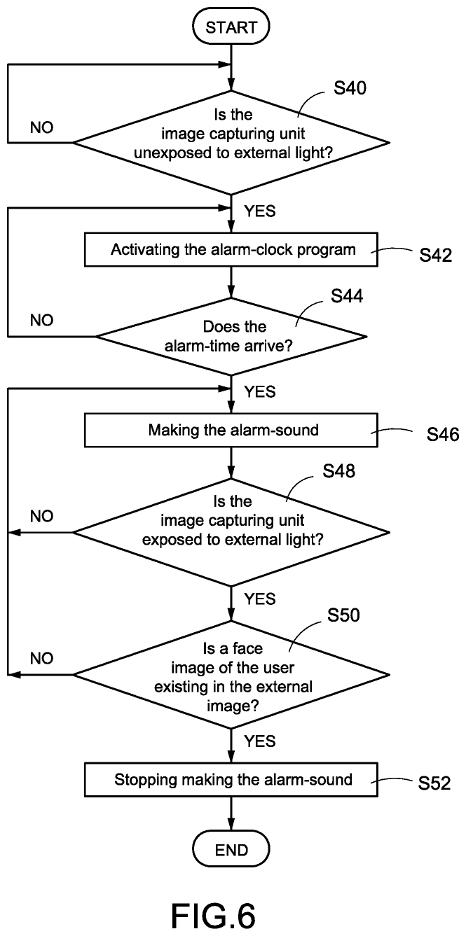

Please refer to FIG. 6, which is a controlling flowchart of alarm-clock according to a second embodiment of the present invention.

A part of users may locate the smart mirror 1 of the present invention in their room, so they can use the smart mirror 1 to perform makeup activities with ease. For preventing the smart mirror 1 from being hacked and affecting user's privacy, the part of users is used to manually cover the image capturing unit 12 before going to bed, so as to protect themselves. In the embodiment as shown in FIG. 6, the image capturing unit 12 is considered matching with the alarm-relieving condition when it is exposed to external light (i.e., when the image capturing unit 12 is not covered).

First, the processor 11 of the smart mirror 1 keeps determining whether the image capturing unit 12 is unexposed to external light (step S40), in other words, the processor 11 keeps determining if the user moves the lens hood 17 for the image capturing unit 12 to be covered by the lens hood 17 (for example, when the user goes to bed). If the image capturing unit 12 keeps being exposed to external light (i.e., not covered by the lens hood 17), the processor 11 goes back to the step S40 for keeping the determination. If the image capturing unit 12 is considered being unexposed to external light (i.e., being covered by the lens hood 17), the processor 11 automatically activates the alarm-clock program 132 (step S42). After the alarm-clock program 132 is activated, the processor 11 keeps determining whether the alarm-time preset by the user arrives (step S44). In this embodiment, the processor 11 keeps monitoring the system time of the smart mirror 1, and determines whether the system time reaches the alarm-time preset by the user. Besides, the processor 11 keeps executing the step S44 before the system time reaches the alarm-time, and controls the smart mirror 1 to make the alarm-sound or the alarm-notification once the system time reaches the alarm-time (step S46).

The processor 11 determines whether the image capturing unit 12 is exposed to external light after the alarm-time arrives (step S48), i.e., the processor 11 determines whether the image capturing unit 12 is free from being covered by the lens hood 17 after the step S46. If the processor 11 determines that the image capturing unit 12 is still unexposed to external light, it means that the lens hood 17 hasn't been removed by the user from the image capturing unit 12 (for example, while the user is still in bed). In this scenario, the processor 11 goes back to the step S46 for controlling the smart mirror 1 to keep making the alarm-sound. If the processor 11 determines that the image capturing unit 12 is now exposed to external light, it means that the lens hood 17 has been removed by the user from the image capturing unit 12 (and the light-exposed status of the image capturing unit 12 matches with the alarm-relieving condition preset by the user), so the processor 11 may control the smart mirror 1 to stop making the alarm-sound.

In one of the exemplary embodiments, the processor 11 may further control the image capturing unit 12 to obtain an external image after determining that the image capturing unit 12 is exposed to external light (i.e., the lens hood 17 has been opened), and determines if a face image of the user is existing in the external image (step S50). In this embodiment, the processor 11 may control the smart mirror 1 to stop making the alarm-sound only if the above three conditions are all accomplished. In particular, the processor 11 may control the smart mirror 1 to stop making the alarm-sound if the alarm-time arrives, the image capturing unit 12 is exposed to external light, and the face image of the user is existing in the external image captured by the image capturing unit 12 (step S52). The processor 11 in this embodiment may confirm that it was the user in the external image who manually opens the lens hood 17 and makes the image capturing unit 12 to be exposed to external light. The smart mirror 1 can be avoided from turning off the alarm-sound due to misjudgment.

In this embodiment, the user can move the lens hood 17 while he or she wants to activate the alarm-clock program 132 (such as going to bed), changes the light-exposed status of the image capturing unit 12 via covering the image capturing unit 12 by the lens hood 17. Also, the user can open the lens hood 17 while he or she wants to turn the alarm-sound off (such as getting up from bed), so as to recover the light-exposed status of the image capturing unit 12.

Also, the processor 11 in this embodiment determines that the image capturing unit 12 is unexposed to external light when the light-strength sensed by the image capturing unit 12 is smaller than a first threshold (or pretends that the image capturing unit 12 is covered by the lens hood 17), and determines that the image capturing unit 12 is exposed to external light when the light-strength sensed by the image capturing unit 12 is bigger than the first threshold (or pretends that the image capturing unit 12 is not covered by the lens hood 17). However, the above descriptions are only few embodiments of the present invention, not intended to limit the scope of the present invention.

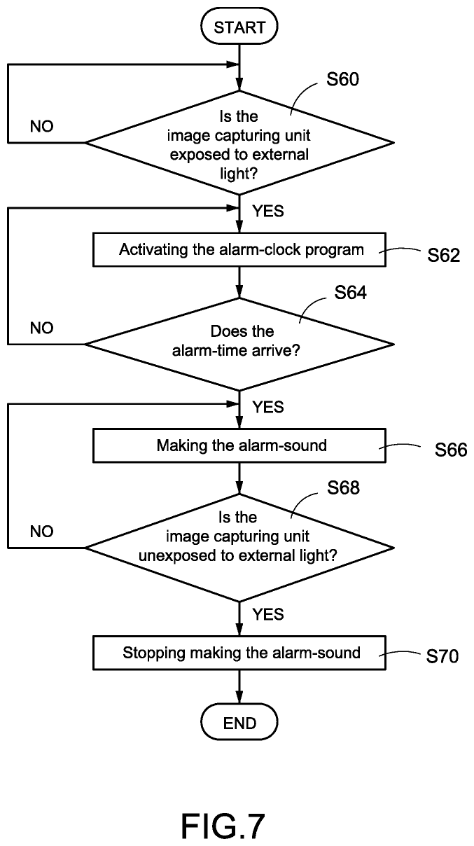

Please refer to FIG. 7, which is a controlling flowchart of alarm-clock according to a third embodiment of the present invention.

A part of users may locate the smart mirror 1 in bathroom or dressing room, so as to perform makeup activities while they're taking shower/changing clothes. If the smart mirror 1 is located in the bathroom or the dressing room, the problem discussed above with respect to FIG. 6 that user's privacy may be leaked during sleeping once the smart mirror 1 is hacked will no longer exists. As a result, this kind of users do not have the habit to intentionally cover the image capturing unit 12 before they go to bed.

However, users may change their clothes while they're in the bathroom or dressing room, so this kind of users may be used to cover the image capturing unit 12 of the smart mirror 1 before changing their clothes in case their privacy is somehow leaked by the smart mirror 1.

According to such scenario, FIG. 7 will be described in an embodiment that the image capturing unit 12 is considered matching with the alarm-relieving condition when it is unexposed to external light (i.e., when the image capturing unit 12 is covered).

First, the processor 11 keeps determining whether the image capturing unit 12 is exposed to external light (step S60), i.e., the processor 11 keeps determining whether the lens hood 17 used to cover the image capturing unit 12 is opened by the user (for example, the lens hood 17 will be opened when the user is done changing his/her clothes). If the image capturing unit 12 is determined being unexposed to external light (i.e., still being covered by the lens hood 17), the processor 11 goes back to the step S60 for keeping the determination. If the image capturing unit 12 is determined being exposed to external light (i.e., no longer covered by the lens hood 17), the processor 11 may automatically activate the alarm-clock program 132 (step S62).

After the alarm-clock program 132 is activated, the processor 11 keeps determining whether the alarm-time preset by the user arrives (step S64). In one of the exemplary embodiments, the processor 11 keeps executing the step S64 for determination before the system time of the smart mirror 1 reaches the alarm-time, and controls the smart mirror 1 to make and emit the alarm-sound or the alarm-notification after the system time reaches the alarm-time (step S66).

After the alarm-time arrives, the processor 11 determines whether the image capturing unit 12 is unexposed to external light (step S68), i.e., the processor 11 determines whether the image capturing unit 12 is covered by the lens hood 17 or not. If the processor 11 determines that the image capturing unit 12 is still exposed to external light, it means that the user has not yet entered the bathroom or the dressing room and the lens hood 17 has not yet been moved to cover the image capturing unit 12, so the processor 11 goes back to the step S66 for controlling the smart mirror 1 to keep making the alarm-sound. If the processor 11 determines that the image capturing unit 12 is unexposed to external light, it means that the user has covered the image capturing unit 12 by the lens hood 17 (for example, when the user wants to change his/her clothes). In the meanwhile, the status of the image capturing unit 12 will be determined matching with the alarm-relieving condition preset by the user, so the processor 11 may control the smart mirror 1 to stop making the alarm-sound (step S70).

By using the technical solutions discussed above, the user is allowed to set the alarm-time as well as the alarm-relieving condition (as the image capturing unit 12 being exposed/unexposed to external light), and activates the alarm-clock program 132 and turns off the alarm-clock program 132 by way of the lens hood 17. In conclusion, the manufacturer of the smart mirror 1 is unnecessary to change the internal electronic components and circuits only for the use of the alarm-clock program 132, so the manufacturing cost can be effectively reduced.

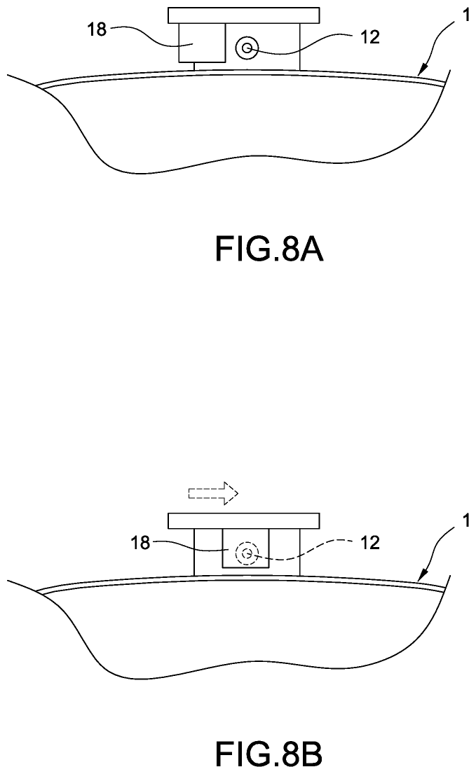

Please refer to FIG. 8A and FIG. 8B, wherein FIG. 8A is a partial enlargement diagram of smart mirror according to a third embodiment of the present invention, FIG. 8B is a partial enlargement diagram of smart mirror according to a fourth embodiment of the present invention. In the embodiment as shown in FIG. 8A and FIG. 8B, the smart mirror 1 may be arranged with another lens hood 18 on its shell, and the arranged position of the lens hood 18 is at a left side or a right side of the image capturing unit 12. In this embodiment, the user may push the lens hood 18 leftward or rightward to achieve the purpose that uses the lens hood 18 to cover the image capturing unit 12, so as to change the light-exposed status of the image capturing unit 12. More specific, in one of the exemplary embodiments, the lens hood 18 can be a frosted glass. When the image capturing unit 12 is covered by the lens hood 18, it can still be slightly exposed to external light, but the external image captured by the image capturing unit 12 may be frosted by the lens hood 18, so it may be applied to the controlling method either disclosed in FIG. 6 or FIG. 7 according to user's requirement.

In the above embodiment as shown in FIG. 3A and FIG. 3B, the lens hood 17 is pressed downward to cover/uncover the image capturing unit 12. In the above embodiment as shown in FIG. 8A and FIG. 8B, the lens hood 18 is pressed leftward or rightward to cover/uncover the image capturing unit 12. However, the lens hood 17, 18 may also be a rotatable lens hood which is rotated to cover/uncover the image capturing unit 12, not limited thereto.

Besides, in another one of the exemplary embodiments, the smart mirror 1 may also be arranged with a rotatable image capturing unit (not shown). In this embodiment, the user may rotate the image capturing unit inwardly (i.e., makes the camera of the image capturing unit to face toward the inner of the shell), so as to cover the image capturing unit. In this embodiment, the smart mirror 1 has no need to arranged the additional lens hood 17 or 18, so the manufacturing cost can be further reduced, and the overall exterior appearance of the smart mirror 1 can be more artistic.

By using the technical solutions disclosed in the present invention, a smart mirror may prevent its image capturing unit from leaking user's privacy through using a specific structure, and controls the on/off status of an alarm-clock function simultaneously through this specific structure, so as to accomplish a complex function as well as saving manufacturing cost.

As the skilled person will appreciate, various changes and modifications can be made to the described embodiment. It is intended to include all such variations, modifications and equivalents which fall within the scope of the present invention, as defined in the accompanying claims.

What is claimed is:

1. A method for controlling alarm-clock, applied in a smart mirror (1), the smart mirror (1) comprising at least one memory (13) for storing an alarm-clock program (132) and an algorithm (131), an image capturing unit (12) for capturing an external image, a processor (11) for performing the algorithm (131) for analyzing the external image, and a display (14) for displaying an analyzing result of the algorithm, wherein the method comprising following steps:
a) activating the alarm-clock program (132) through the processor (11);
b) determining whether a preset alarm-time of the smart mirror (1) arrives after the step a);
c) making an alarm-sound or alarm-notification whenever the alarm-time arrives;
d) determining whether a status of the image capturing unit (12) matches with a preset alarm-relieving condition of the smart mirror (1) after the alarm-time arrives; and
e) stopping making the alarm-sound or alarm-notification when the status of the image capturing unit (12) is determined by the processor (11) matching with the alarm-relieving condition.

2. The method for controlling alarm-clock in claim 1, further comprising following steps before the step a):
a1) activating the smart mirror (1);
a2) setting the alarm-time;
a3) setting the alarm-relieving condition, wherein the alarm-relieving condition at least comprises the image capturing unit (12) being exposed to external light and the image capturing unit (12) being unexposed to external light; and
a4) storing the alarm-time and the alarm-relieving condition.

3. The method for controlling alarm-clock in claim 1, wherein the step d) is to determine whether a light-exposed status of the image capturing unit (12) matches with the alarm-relieving condition.

4. The method for controlling alarm-clock in claim 3, wherein the processor (11) determines that the image capturing unit (12) is unexposed to external light if a light-strength sensed by the image capturing unit (12) is smaller than a first threshold, and determines that the image capturing unit (12) is exposed to external light if the light strength sensed by the image capturing unit (12) is bigger than the first threshold.

5. The method for controlling alarm-clock in claim 3, wherein the step a) activates the alarm-clock program (132) when the image capturing unit (12) is determined being unexposed to external light, and the step b) determines that the status of the image capturing unit (12) matches with the alarm-relieving condition when the image capturing unit (12) is determined being exposed to external light.

6. The method for controlling alarm-clock in claim 3, wherein the step a) activates the alarm-clock program (132) when the image capturing unit (12) is determined being exposed to external light, and the step b) determines that the status of the image capturing unit (12) matches with the alarm-relieving condition when the image capturing unit (12) is determined being unexposed to external light.

7. The method for controlling alarm-clock in claim 1, wherein the smart mirror (1) comprises a lens hood (17, 18), the lens hood (17, 18) is configured to cover the image capturing unit (12) for changing a light-exposed status of the image capturing unit (12).

8. The method for controlling alarm-clock in claim 7, wherein the image capturing unit (12) is unexposed to external light when being covered by the lens hood (17, 18), and is exposed to external light when not being covered by the lens hood (17, 18).

9. The method for controlling alarm-clock in claim 7, wherein the lens hood (17, 18) is a frosted glass.

10. The method for controlling the alarm-clock in claim 1, wherein the smart mirror (1) comprises an auxiliary light source for light compensation, the step c) controls the auxiliary light source to emit light for making the alarm-notification with the alarm-sound while the alarm-time arrives, or only controls the auxiliary light source to emit light for making the alarm-notification instead of the alarm-sound while the alarm-time arrives.

11. The method for controlling the alarm-clock in claim 10, wherein the auxiliary light source is capable of emitting light with different color temperatures, the step c) sets the color temperature of the emitted light according to user requirement.

12. A method for controlling alarm-clock, applied to a smart mirror (1), the smart mirror (1) at least having a memory (13) for storing an alarm-clock program (132) and an algorithm (131), an image capturing unit (12) for capturing an external image, a processor (11) for performing the algorithm (131) for analyzing the external image, and a display (14) for displaying an analyzing result of the algorithm (131), and the method comprising following steps:
a) activating the alarm-clock program (132) by the processor (11);
b) determining whether a system time of the smart mirror (11) reaches a preset alarm-time of the smart mirror (1) by the processor (11) after the step a);
c) executing the step b) continually before the system time reaches the alarm-time;
d) making an alarm-sound or alarm-notification whenever the system time reaches the alarm-time;
e) determining whether the image capturing unit (12) is exposed to external light after the system time reaches the alarm-time;
f) making the alarm-sound continually if the image capturing unit (12) is determined being unexposed to external light; and
g) stopping making the alarm-sound after the image capturing unit (12) is determined being exposed to external light;
wherein, the smart mirror (1) comprises a movable lens hood (17, 18), the image capturing unit (12) is determined being unexposed to external light when being covered by the lens hood (17, 18), and is determined being exposed to external light when not being covered by the lens hood (17, 18).

13. The method for controlling alarm-clock in claim 12, wherein the processor (11) automatically activates the alarm-clock program (132) when the system time reaches an activating time, or automatically activates the alarm-clock program (132) when the image capturing unit (12) is determined being unexposed to external light.

14. The method for controlling alarm-clock in claim 12, wherein the processor (11) determines that the image capturing unit (12) is unexposed to external light if a light strength sensed by the image capturing unit (12) is smaller than a first threshold, and determines that the image capturing nit (12) is exposed to external light if the light strength sensed by the image capturing unit (12) is bigger than the first threshold.

15. The method for controlling alarm-clock in claim 12, further comprising a step e1):
controlling the image capturing unit (12) to obtain the external image and identifying whether a face image of a user is existing in the external image;
wherein, the step g) stops making the alarm-clock sound when the image capturing unit (12) is determined being exposed to external light and the face image of the user is determined existing in the external image obtained by the image capturing unit (12).
